(19) United States
(12) Patent Application Publication
(10) Pub. No.: US 2014/0362039 A1
(43) Pub. Date: Dec. 11, 2014

(54) INPUT DEVICE, INFORMATION PROCESSING DEVICE, AND PROGRAM

(71) Applicant: FUJITSU LIMITED, Kawasaki-shi (JP)

(72) Inventor: TOMOHITO IWAMURA, Kawasaki (JP)

(73) Assignee: FUJITSU LIMITED, Kawasaki-shi (JP)

(21) Appl. No.: 14/272,035

(22) Filed: May 7, 2014

(30) Foreign Application Priority Data
Jun. 7, 2013 (JP) 2013-120757

(51) Int. Cl. G06F 3/041; G06F 3/045; G06F 3/044

(52) U.S. Cl. CPC G06F 3/0416; G06F 3/044; G06F 3/045
USPC 345/174; 345/173

(57) ABSTRACT

An input device includes a first detection unit which is configured to detect contact of an object with a contact surface to detect a contact position of the object, a second detection unit which is provided on the side opposite to the contact surface and which is configured to detect a contact position of the object when a pressure upon contact of the object is equal to or greater than a reference pressure, and a third detection unit which is configured to detect a contact position at a detection timing for detecting a contact position of the object, based on first and second contact positions that are detected by the second detection unit within a predetermined period of time since the detection timing, when the second detection unit does not detect a contact position at the detection timing but the first detection unit detects contact at the detection timing.

### CROSS-REFERENCE TO RELATED APPLICATION

This application is based upon and claims the benefit of priority of the prior Japanese Patent Application No. 2013-120757, filed on Jun. 7, 2013, the entire contents of which are incorporated herein by reference.

### FIELD

The embodiments discussed herein are related to an input device, an information processing device, and a program.

### BACKGROUND

There is proposed an input device that has a first detection unit for detecting contact or approach of an object onto a contact surface to detect a contact position of the object, and a second detection unit for detecting a contact position of the object when the pressure upon contact of the object is equal to or greater than a reference pressure. This input device inputs the contact position of the object detected by the first detection unit or the second detection unit into another device, and the other device executes a process corresponding to the input contact position of the object.

The first detection unit has, for example, an electrostatic capacitive touch panel. The second detection unit has, for example, a resistance film type touch panel.

(Related Art) Japanese Laid-open Patent Publication No. 2012-18660

### SUMMARY

The electrostatic capacitive touch panel detects a contact position based on a value of electrostatic capacitance between electrodes or a current flowing from electrodes. The electrostatic capacitance generated when a conductive object (e.g., a finger) approaches or comes into contact with the contact surface. The electrostatic capacitive touch panel, therefore, can detect a contact position as long as a conductive object gently touches the contact surface (feather touch). However, the electrostatic capacitive touch panel does not detect a contact position when a non-conductive object approaches or comes into contact with the contact surface.

The resistance film type touch panel, on the other hand, has a first transparent conductive film and a second transparent conductive film disposed opposite the first transparent conductive film. The resistance film type touch panel detects a contact position based on an electrical potential that is detected when the first transparent conductive film and the second transparent conductive film are brought into contact with each other by an external pressure. In order to allow the resistance film type touch panel to detect the contact position, the external pressure needs to be equal to or greater than the reference pressure to bring the first and second transparent conductive films into contact with each other. However, because an external pressure equal to or greater than the reference pressure is enough for the resistance film type touch panel to detect the contact position, the conductivity of an object as the external pressure is not taken into consideration.

As described above, a conductive object needs to approach or come into contact with the contact surface of the electrostatic capacitive touch panel in order to allow the electrostatic capacitive touch panel to detect the contact position, in which case an external pressure equal to or greater than the reference pressure does not need to be applied to the contact surface as in the resistance film type touch panel. The resistance film type touch panel, on the other hand, is capable of detecting a contact position of a non-conductive object, but an external pressure equal to or greater than the reference pressure needs to be applied to its contact surface when the object comes into contact therewith.

Therefore, for example, in an input device with a combination of an electrostatic capacitive touch panel and a resistance film type touch panel, when an operator performs a contact operation on the contact surface by using a non-conductive object in which the pressure upon contact is likely to decrease, the contact position might not be able to be detected with high accuracy. Examples of this contact operation where the pressure upon contact is likely to decrease, include an operation where the operator gently swipes the object on the contact surface (also called “flick”).

According to an aspect of the embodiments, an input device includes: a first detection unit which is configured to detect contact of an object with a contact surface to detect a contact position of the object; a second detection unit which is provided on the side opposite to the contact surface and which is configured to detect a contact position of the object when a pressure upon contact of the object is equal to or greater than a reference pressure; and a third detection unit which is configured to detect a contact position at a detection timing for detecting a contact position of the object, based on first and second contact positions that are detected by the second detection unit within a predetermined period of time since the detection timing, when the second detection unit does not detect a contact position at the detection timing but the first detection unit detects contact at the detection timing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of a diagram illustrating a general overview of the input device according to the present embodiment.

FIG. 2 is an example of a diagram for schematically explaining an internal structure of the input device.

FIG. 3 is an example of a block diagram for explaining a configuration of the input device.

FIG. 4 is an example of a block diagram for explaining a hardware configuration of the input device.

FIG. 5 is an example of a block diagram for explaining a software configuration of the input device.

FIG. 6 is a diagram for explaining the process for computing the vector of a contact position, which is executed by the resistance film-side driver, and the process for detecting a contact position, which is detected by the contact position detection unit.

FIG. 7 is an example of a flowchart for explaining a flow of the process for detecting the contact position of an object, which is executed by the contact position detection unit.

FIGS. 8A and 8B are examples of a timing chart for explaining the contact position detection process executed by the contact position detection unit.

FIG. 9 is another example of the flowchart for explaining the flow of the process for detecting a contact position of an object, which is executed by the contact position detection unit.

FIG. 10 is an example of a block diagram for explaining a configuration of an information processing device.

FIG. 11 is an example of a block diagram for explaining a hardware configuration of the information processing device.

FIG. 12 is an example of a block diagram for explaining a software configuration of the information processing device.

### DESCRIPTION OF EMBODIMENTS

### First Embodiment

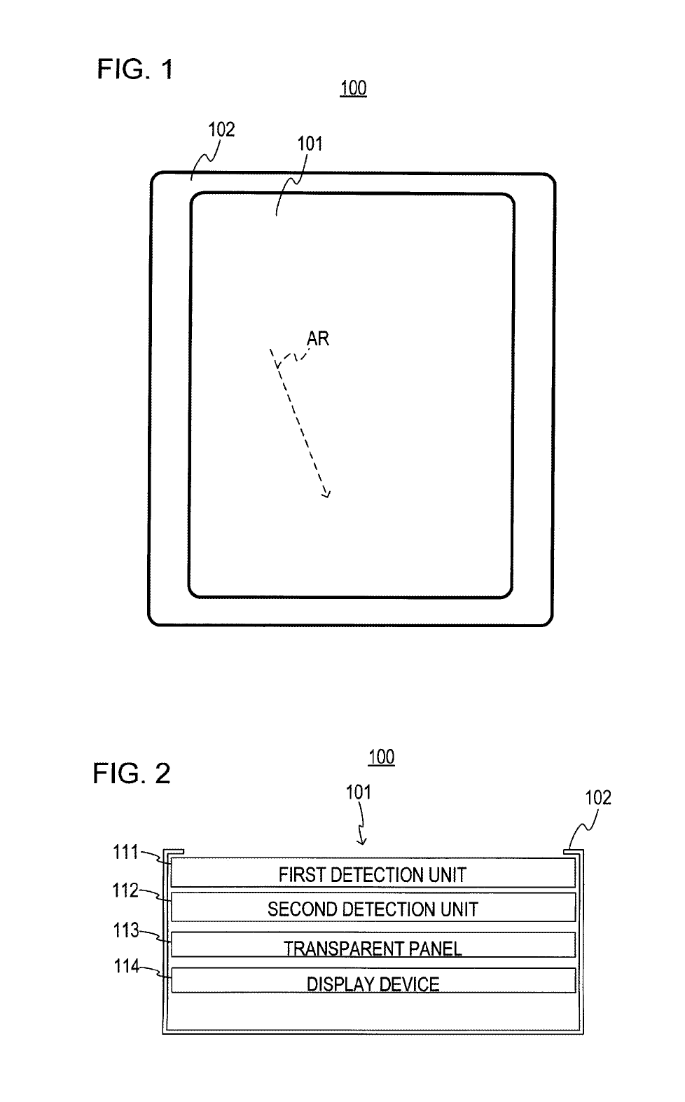

An input device according to the present embodiment is described hereinafter with reference to FIGS. 1 to 9. Note that like reference numerals are used for indicating the same elements in the following descriptions; thus, the overlapping explanations are omitted accordingly.

(General Overview of Input Device)

FIG. 1 is an example of a diagram illustrating a general overview of the input device according to the present embodiment. The input device 100 has a contact surface 101 and an external housing 102. The input device 100 displays various information such as images, characters, and symbols, various types of manipulandum such as buttons and icons, character input areas, and the like, on the contact surface 101.

An operator uses a conductive object (e.g., a finger) or a non-conductive object (e.g., a piece of plastic, a nail) to touch the contact surface 101 and moves the object along the arrow AR (also referred to as “contact operation”). Consequently, the input device 100 detects a contact position of the object.

(Internal Structure of Input Device)

FIG. 2 is an example of a diagram for schematically explaining an internal structure of the input device 100. The input device 100 has a first detection unit 111, a second detection unit 112, a transparent panel 113, and a display device 114.

The first detection unit 111 detects contact of the object with the contact surface 101 to detect a contact position of the object. The first detection unit 111 has, for example, an electrostatic capacitive touch panel and a controller for controlling the drive of the electrostatic capacitive touch panel.

The second detection unit 112 is provided on the side opposite to the contact surface 101 and detects a contact position of the object when a pressure upon contact of the object is equal to or greater than a reference pressure. The second detection unit 112 has, for example, a resistance film type touch panel and a controller for controlling the drive of the resistance film type touch panel. As illustrated in FIG. 2, the first detection unit 111 is stacked on top of the second detection unit 112.

The transparent panel 113 is an acrylic or glass panel and provided between the second detection unit 112 and the display device 114. The display device 114 has, for example, a liquid crystal or organic electroluminescence (organic EL) display panel and a controller for controlling the drive of this display panel. The display device 114 displays various information such as images, characters, and symbols. The various information displayed by the display device 114 are displayed on the contact surface 101 through the transparent panel 113, the second detection unit 112, and the first detection unit 111.

As described above, a conductive object needs to approach or come into contact with the contact surface of the electrostatic capacitive touch panel in order to allow the electrostatic capacitive touch panel to detect the contact position, in which case an external pressure equal to or greater than the reference pressure does not need to be applied to the contact surface as in the resistance film type touch panel. In case of the resistance film type touch panel, on the other hand, an external pressure equal to or greater than the reference pressure needs to be applied upon contact of an object in order to detect the contact position, but the conductivity of the object for applying the external pressure is not taken into consideration.

In view of such characteristics of the electrostatic capacitive touch panel and of the resistance film type touch panel, the input device 100 is configured as illustrated in FIG. 2 to detect a contact position of a conductive or non-conductive object when the operator gently touches the contact surface 101 of the input device 100 with the conductive or non-conductive object.

For instance, in the input device 100, the first detection unit 111 with the electrostatic capacitive touch panel is provided on the contact surface 101 side, and the second detection unit 112 with the resistance film type touch panel is provided therebelow. In other words, the resistance film type touch panel is provided on the side opposite to the electrostatic capacitive touch panel on the contact surface 101 side.

According to the input device 100 in this type of structure, the electrostatic capacitive touch panel detects the contact position when the operator gently touches the contact surface 101 with the conductive object. Even when the non-conductive object comes into contact with the contact surface 101, the pressure upon contact is transmitted to the resistance film type touch panel through the electrostatic capacitive touch panel, allowing the resistance film type touch panel to detect the contact position.

Accordingly, the input device 100 can detect a contact position on the contact surface 101 whether the object coming into contact therewith is a conductive object or a non-conductive object. Even in a case where water, for example, adheres to the contact surface 101 and prevents the electrostatic capacitive touch panel from detecting a contact position with high accuracy, contact of an object can be detected.

However, because the pressure upon contact is transmitted to the resistance film type touch panel through the electrostatic capacitive touch panel in the input device 100 illustrated in FIG. 2, the pressure upon contact to be transmitted to the resistance film type touch panel becomes weak.

Therefore, when bringing a non-conductive object into contact with the contact surface 101 of the input device 100, the operator needs to touch the resistance film type touch panel at a pressure stronger than when bringing the object into direct contact therewith, in order to allow the resistance film type touch panel to detect the contact position of the object. As a result, when the pressure upon contact of the non-conductive object decreases (also referred to as “released load”) in the input device 100, the resistance film type touch panel often does not detect the contact position.

For example, suppose that an application for rendering, on the contact surface 101, a trace of contact positions of an object on the contact surface 101 is executed in the input device 100. In this case, the operator performs an operation on the contact surface 101 by using a non-conductive object in which the pressure upon contact is likely to drop, the resistance film type touch panel does not detect a contact position, resulting in pausing the rendering process. Flicking or swiping is the operation that leads to a decrease in the pressure upon contact. Swiping is an operation where the operator swings an object left and right when, for example, writing a character such as a Chinese character, hiragana, or katakana on the contact surface 101.

In the input device 100 according to the present embodiment, detection processes described below are executed to detect a contact position of a non-conductive object with high accuracy even when the contact pressure of the object on the contact surface 101 is reduced.

(Configuration of Input Device)

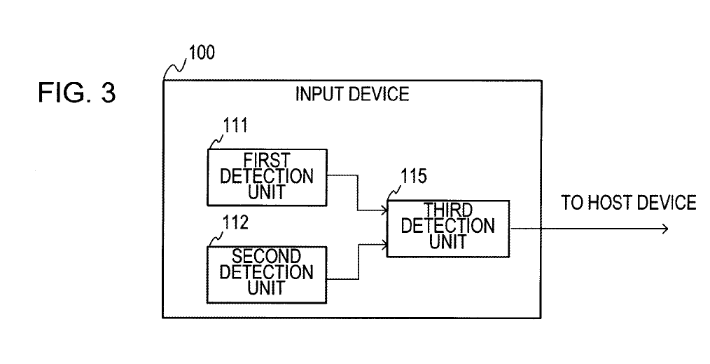

FIG. 3 is an example of a block diagram for explaining a configuration of the input device 100. The input device 100 has the first detection unit 111, the second detection unit 112, and a third detection unit 115. In a case where the second detection unit 112 does not detect a contact position but the first detection unit 111 detects contact at the timing for detecting a contact position of an object (appropriately referred to as “detection timing,” hereinafter), the third detection unit 115 executes the following processes. That is, the third detection unit 115 detects a contact position at the detection timing based on first and second contact positions that are detected by the second detection unit 112 within a predetermined period of time since the detection timing.

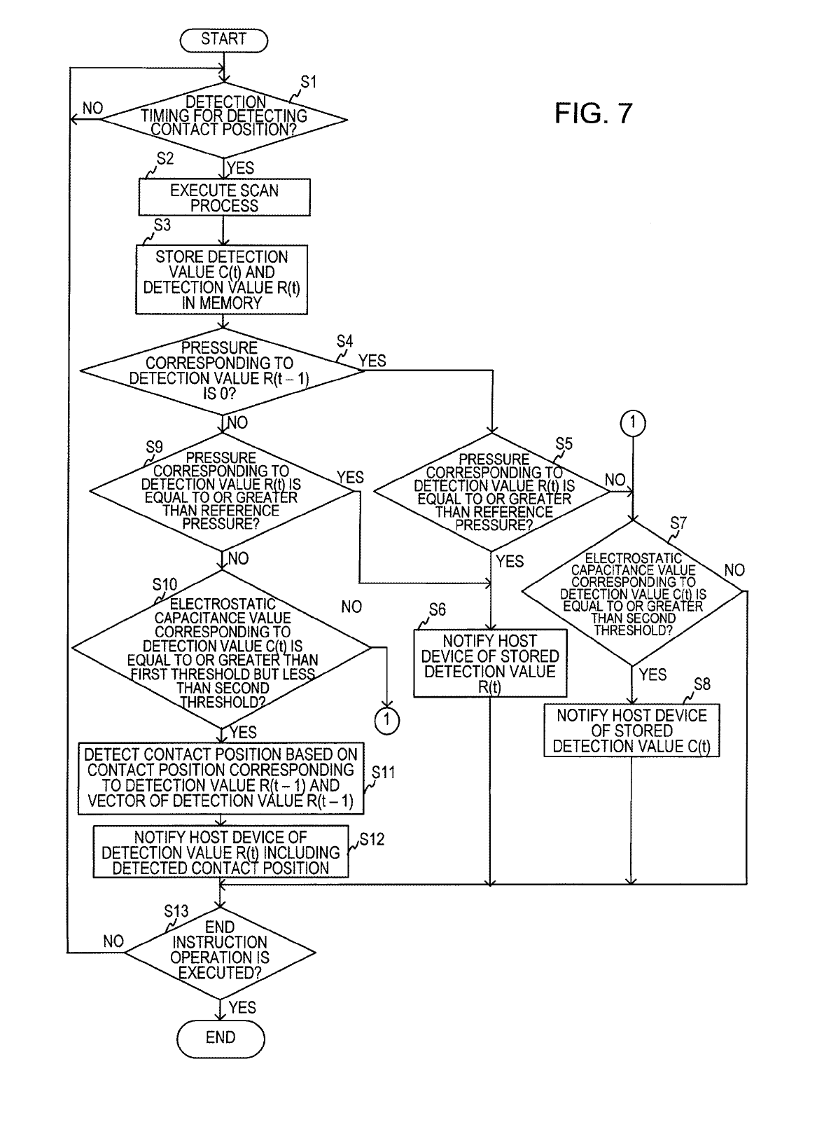

The third detection unit 115 then notifies a host device of the contact position of the object detected by the first detection unit 111, the contact positions of the object detected by the second detection unit 112, or the contact position of the object detected by the third detection unit 115. The host device is a device that executes an information process in accordance with the contact position, such as an information processing device. Note that this notification of the contact position is described hereinafter in detail with reference to FIG. 7.

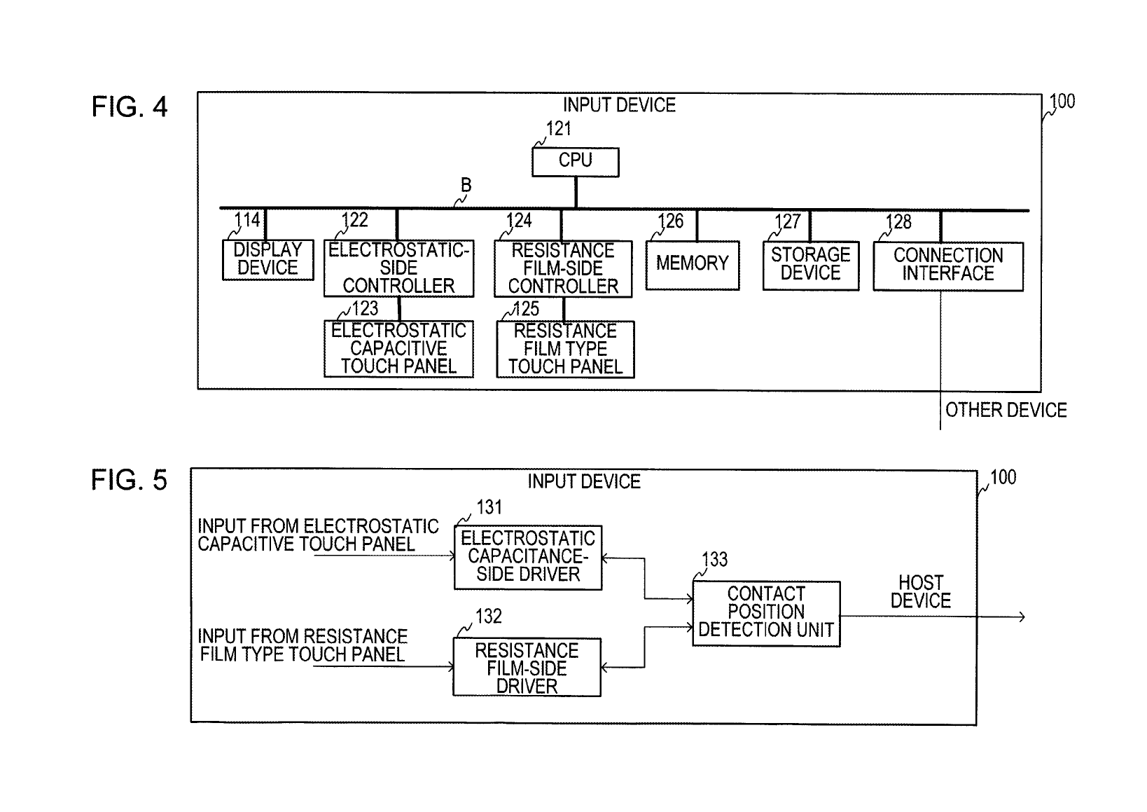

According to the input device of the present embodiment, even when the pressure upon contact of a non-conductive object is less than the reference pressure and for this reason the first detection unit 111 and the second detection unit 112 do not detect any contact positions at the detection timing, the third detection unit 115 detects a contact position at the detection timing. Thus, the input device 100 can detect contact positions with high accuracy even when the non-conductive object executes a flicking operation or other operations where the pressure upon contact thereof is likely to drop. The configuration of the input device 100 is described next specifically with reference to FIGS. 4 to 9.

(Hardware Configuration of Input Device)

FIG. 4 is an example of a block diagram for explaining a hardware configuration of the input device 100. The input device 100 has a central processing unit (CPU) 121, the display device 114, an electrostatic-side controller 122, and an electrostatic capacitive touch panel 123, all of which are connected to a bus B. The input device 100 further has a resistance film-side controller 124, a resistance film type touch panel 125, a memory 126, a storage device 127, and a connection interface 128, all of which are connected to the bus B.

The CPU 121 is a processor for controlling the entire input device 100. The electrostatic-side controller 122 controls the drive of the electrostatic capacitive touch panel 123.

The electrostatic capacitive touch panel 123 is now explained briefly. There exist two types of electrostatic capacitive systems: projected capacitive type and surface capacitive type.

The projected capacitive touch panel has, for example, a transparent body such as a transparent film or a printed circuit board, and a matrix electrode pattern formed in the transparent body. Specifically, the projected capacitive touch panel has a plurality of electrodes disposed therein.

The electrostatic-side controller 122 detects a change in electrostatic capacitance generated between the plurality of electrodes in the projected capacitive touch panel (also referred to as “capacitance change,” “electrostatic capacitance value”) when a conductive object (e.g., a finger) comes into contact with the touch panel. The electrostatic-side controller 122 detects a contact position of the object based on this detected electrostatic capacitance value.

The surface capacitive touch panel has, for example, a square substrate layer, a conductive film provided on the substrate layer, and electrodes connected to the four corners of the conductive film. In other words, the surface capacitive touch panel has a plurality of electrodes disposed therein.

The electrostatic-side controller 122 applies voltage to the four electrodes of the surface capacitive touch panel to form a uniform electric field on the entire panel. When a conductive object such as a finger comes into contact with the surface capacitive touch panel, a current flows from the four electrodes through the finger. The electrostatic-side controller 122 detects the ratio of the current flowing from the four electrodes, and the driver of the electrostatic-side controller 122 detects a contact position of the object. For convenience of explanation, in the following embodiments the electrostatic capacitive touch panel 123 is described as the projected capacitive touch panel.

Note that the first detection unit 111 illustrated in FIGS. 2 and 3 has, for example, the electrostatic capacitive touch panel 123 and the electrostatic-side controller 122 for controlling the drive of the electrostatic capacitive touch panel 123.

The resistance film-side controller 124 controls the drive of the resistance film type touch panel 125. The resistance film type touch panel 125 is now explained briefly. The resistance film type touch panel 125 has a first transparent conductive film, a second transparent conductive film disposed opposite the first transparent conductive film, and a spacer provided between the first transparent conductive film and the second transparent conductive film. Note that the first transparent conductive film is provided on a film material that is applied with external pressure, and the second transparent conductive film is provided on a glass substrate.

When a conductive object or a non-conductive object comes into contact with the film material and the film material is consequently bent, the first transparent conductive film provided on the film material comes into contact with the second transparent conductive film provided on the glass substrate. The pressure used for this contact corresponds to the reference pressure.

The resistance film-side controller 124 detects contact resistance values of the first and second transparent conductive films. The resistance film-side controller 124 further detects an electrical potential at the place where the first transparent conductive film and the second transparent conductive film come into contact with each other. The resistance film-side controller 124 detects a contact position of the object based on the detected electrical potential.

The second detection unit 112 illustrated in FIGS. 2 and 3 has, for example, the resistance film type touch panel 125 and the resistance film-side controller 124 for controlling the drive of the resistance film type touch panel 125.

The memory 126 is, for example, a random access memory (RAM) and temporarily stores, for example, results of the processes executed by the CPU 121 and various programs. The storage device 127 is, for example, any of various storage devices such as a flash memory. The connection interface 128 is an interface for communicably connecting the input device 100 and the other device (not illustrated). The other device is, for example, the host device.

(Software Configuration of Input Device)

FIG. 5 is an example of a block diagram for explaining a software configuration of the input device 100. The input device 100 has an electrostatic capacitance-side driver 131, a resistance film-side driver 132, and a contact position detection unit 133.

The electrostatic capacitance-side driver 131 is a program for controlling the electrostatic capacitive touch panel 123 illustrated in FIG. 4 (also referred to as “driver”). The electrostatic capacitance-side driver 131 is a so-called software module, and a program for executing the electrostatic capacitance-side driver 131 is stored in, for example, a read only memory (ROM), not illustrated, which is provided in the electrostatic-side controller 122. The electrostatic-side controller 122 functions as the software module of the electrostatic capacitance-side driver 131 by reading this program for executing the electrostatic capacitance-side driver 131 from the ROM and expanding the program into a RAM (not illustrated) of the electrostatic-side controller 122 at the activation of the input device 100.

An electrostatic capacitance value of the electrostatic capacitive touch panel 123 is input to the electrostatic capacitance-side driver 131. Once the electrostatic capacitance-side driver 131 receives from the contact position detection unit 133 an instruction on the execution of a detection process (also referred to as “scan process”), the electrostatic capacitance-side driver 131 detects a contact position based on the detected electrostatic capacitance value. The electrostatic capacitance-side driver 131 then inputs the electrostatic capacitance value and the contact position into the contact position detection unit 133.

The detected electrostatic capacitance value is now described. Three possible states are simulated below. The first state is where no object is in contact with the electrostatic capacitive touch panel 123. The second state is where a non-conductive object is in contact with the electrostatic capacitive touch panel 123. The third state is where a conductive object is in contact with the electrostatic capacitive touch panel 123.

In these three states, the first electrostatic capacitance value detected in the first state is the smallest, and the third electrostatic capacitance value detected in the third state is the largest. The second electrostatic capacitance value detected in the second state is an intermediate value between the first electrostatic capacitance value and the third electrostatic capacitance value. This is because a small electrostatic capacitance value can be detected even in the second state (in which a non-conductive object is in contact with the electrostatic capacitive touch panel 123). However, such small electrostatic capacitance value does not enable highly accurate detection of a contact position.

The electrostatic capacitance-side driver 131 does not execute the process for detecting a contact position of an object when the detected electrostatic capacitance value is less than a first threshold (corresponding to the first state). However, the electrostatic capacitance-side driver 131 executes the process for detecting a contact position of an object when the electrostatic capacitance value is equal to or greater than a second threshold that is greater than the first threshold (corresponding to the third state).

The contact position detection unit 133, however, determines that contact of an object is detected, when the electrostatic capacitance value is equal to or greater than the first threshold but less than the second threshold, and the result of determination is used in detection of a contact position by the resistance film-side driver 132. More specifically, the contact position detection unit 133 determines, for example, whether the input electrostatic capacitance value is equal to or greater than the first threshold but less than the second threshold. When the input electrostatic capacitance value is equal to or greater than the first threshold but less than the second threshold (corresponding to the second state), the contact position detection unit 133 determines that an object is in contact with the touch panel. Once the contact position detection unit 133 determines that an object is in contact with the touch panel, the resistance film-side driver 132 estimates a current contact position from the detected contact position.

The resistance film-side driver 132 is a program for controlling the resistance film type touch panel 125 illustrated in FIG. 4. The resistance film-side driver 132 is a so-called software module, and a program for executing the resistance film-side driver 132 is stored in, for example, a ROM (not illustrated) of the resistance film-side controller 124. The resistance film-side controller 124 functions as the software module of the resistance film-side driver 132 by reading this program for executing the resistance film-side driver 132 from the ROM and expanding the program into a RAM (not illustrated) of the resistance film-side controller 124 at the activation of the input device 100.

A contact resistance value and electrical potential of the resistance film type touch panel 125 are input to the resistance film-side driver 132. Upon receipt of an instruction on the execution of the scan process from the contact position detection unit 133, the resistance film-side driver 132 executes the following processes. Specifically, the resistance film-side driver 132 detects a contact position from an electrical potential that is detected when an object comes into contact with the front surface (on the film material side) of the resistance film type touch panel 125 and consequently the first transparent conductive film and the second transparent conductive film come into contact with each other. Furthermore, the resistance film-side driver 132 detects the pressure upon contact of the object, based on the detected contact resistance values of the first transparent conductive film and the second transparent conductive film.

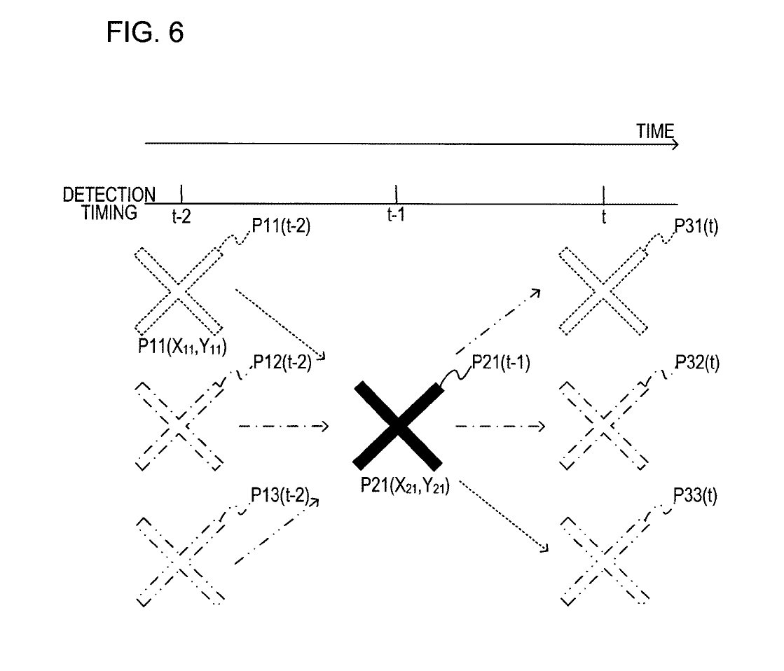

The resistance film-side driver 132 further computes the vector of a contact position detected at the detection timing. The vector of a contact position is computed based on a contact position detected at the detection timing and a contact position detected at, for example, a detection timing preceding the aforementioned detection timing. How the vector of a contact position is computed is described with reference to FIG. 6. The resistance film-side driver 132 inputs the detected pressure and contact position of the object as well as the vector of the contact position into the contact position detection unit 133.

The contact position detection unit 133 executes the process for detecting a contact position by using the inputs received from the electrostatic capacitance-side driver 131 and the resistance film-side driver 132. For example, at each detection timing, the contact position detection unit 133 instructs the electrostatic capacitance-side driver 131 and the resistance film-side driver 132 to execute the scan process. The detection timings occur at a fixed time interval. The fixed time interval is, for example, 16 milliseconds.

The contact position detection unit 133 determines whether an object comes into contact with the contact surface 101. As described above, when the input electrostatic capacitance value is equal to or greater than the first threshold but less than the second threshold (corresponding to the second state), the contact position detection unit 133 determines that an object is in contact with the contact surface 101. Note that the electrostatic capacitance-side driver 131 may determine whether an object is in contact with the contact surface 101. In such a case, the electrostatic capacitance-side driver 131 inputs, to the contact position detection unit 133, the result of determination indicating whether an object is in contact with the contact surface 101.

In addition, the contact position detection unit 133 executes the detection process that is detected by the third detection unit 115 described with reference to FIG. 3. In other words, the contact position detection unit 133 is an example of the third detection unit 115.

The contact position detection unit 133 is a so-called software module, and a program for executing the contact position detection unit 133 is stored in the storage device 127 illustrated in FIG. 4. At the activation of the input device 100, the CPU 121 illustrated in FIG. 4 reads this program stored in the storage device 127 and expands the program into the memory 126, to thereby cause the program to function as the software module of the contact position detection unit 133.

(Vector Computation Process, Process for Detecting Contact Position)

FIG. 6 is a diagram for explaining the process for computing the vector of a contact position, which is executed by the resistance film-side driver 132, and the process for detecting a contact position, which is detected by the contact position detection unit 133. In the following description, the current detection timing is appropriately described as “detection timing (t).” The detection timing that precedes the current detection timing (t) by “k” is described as “detection timing (t−k).” Note that the reference numeral k indicates an integer of 1 or more. In addition, the detection timing that succeeds the current detection timing (t) by “k” is described as “detection timing (t+k).”

In the following description, suppose that the resistance film-side driver 132 detects a contact position of an object on the contact surface 101 at a detection timing (t−2) and a detection timing (t−1). However, the resistance film-side driver 132 does not detect a contact position of the object on the contact surface 101 at the detection timing (t), but the contact position detection unit 133 detects a contact position of the object on the contact surface 101.

The arrows in FIG. 6 represent lapses of time, and below the arrows are the detection timing (t−2), the detection timing (t−1), and the detection timing (t). Reference numerals P11 (t−2), P12 (t−2), and P13 (t−2) illustrated in FIG. 6 schematically indicate the contact positions of the object on the contact surface 101 that are detected by the resistance film-side driver 132 at the detection timing (t−2). Reference numeral P21 (t−1) schematically indicates the contact position of the object on the contact surface 101 detected by the resistance film-side driver 132 at the detection timing (t−1). Reference numerals P31 (t), P32 (t) and P33 (t) each schematically indicate the contact position of the object on the contact surface 101 detected by the contact position detection unit 133 at the detection timing (t).

First of all, the vector computation process executed by the resistance film-side driver 132 is described. The process is described with an example of computing the vector of the contact position P21 (t−1). Suppose that the contact position detected at the detection timing (t−2) is the contact position P11 (t−2) and that the coordinates thereof are P11 (X₁₁, Y₁₁). Suppose also that the coordinates of the contact position P21 (t−1) are P21 (X₂₁, Y₂₁). At this moment, the resistance film-side driver 132 computes a vector B21 (X₂₁−X₁₁, Y₂₁−Y₁₁) as the vector of the contact position P21 (t−1), which is the difference between the coordinates P21 (X₂₁, Y₂₁) and the coordinates P11 (X₁₁, Y₁₁).

The contact position detection process executed by the contact position detection unit 133 is described next. Suppose here that the resistance film-side driver 132 detects a contact position of an object on the contact surface 101 at the detection timing (t−2) and the detection timing (t−1).

Suppose here that a non-conductive object comes into contact with the electrostatic capacitive touch panel 123 at the detection timing (t) and that the pressure upon contact of this object with the resistance film type touch panel 125 is less than the reference pressure. In this case, the electrostatic capacitance-side driver 131 detects the contact of the object at the detection timing (t), whereas the resistance film-side driver 132 does not detect a contact position of the object.

Consequently, the contact position detection unit 133 detects a contact position of the object on the contact surface 101 based on the contact position P21 (t−1) and the vector of the contact position P21 (t−1) at the detection timing (t). Because the contact position detection unit 133 obtains the contact position of the object at the detection timing (t) in the aforementioned example, the coordinates P21 (X₂₁, Y₂₁) of the contact position P21 (t−1) and the vector B21 (X₂₁−X₁₁, Y₂₁−Y₁₁) are added up. The resultant coordinates are P33 (2X₂₁−X₁₁, 2Y₂₁−Y₁₁), and this contact position is expressed as P33 (t).

In a case where the contact position of the object detected at the detection timing (t−2) is P12 (t−2) or P13 (t−2), the contact position of the object obtained at the detection timing (t) is detected as the contact position P32 (t) or contact position P31 (t).

(Flow of Process for Detecting Contact Position of Object)

FIG. 7 is an example of a flowchart for explaining a flow of the process for detecting the contact position of an object, which is executed by the contact position detection unit 133.

Step S1: The contact position detection unit 133 determines whether a detection timing for detecting a contact position is reached or not. More specifically, the contact position detection unit 133 determines whether a control signal indicating the detection timing is input from an operating system (OS) or the like. When the detection timing is not yet reached (step S1/NO), the determination process of step S1 is continued. When the detection timing is reached (step S1/YES), the contact position detection unit 133 proceeds to step S2.

Step S2: The contact position detection unit 133 instructs the electrostatic capacitance-side driver 131 and the resistance film-side driver 132 to execute the scan process (described appropriately as “scan instruction,” hereinafter). In response to the scan instruction from the contact position detection unit 133, the electrostatic capacitance-side driver 131 executes the scan process and inputs an electrostatic capacitance value and a contact position of an object into the contact position detection unit 133. In response to the scan instruction from the contact position detection unit 133, the resistance film-side driver 132 executes the scan process and inputs the pressure upon contact of the object, a contact position of the object, and the vector of the contact position into the contact position detection unit 133.

In the following description, the electrostatic capacitance value and the contact position of the object that are input to the contact position detection unit 133 by the electrostatic capacitance-side driver 131 at the detection timing (t) are described collectively as “detection value C (t).” In addition, the electrostatic capacitance value and the contact position of the object that are input to the contact position detection unit 133 by the electrostatic capacitance-side driver 131 at the detection timing (t−k) are described collectively as “detection value C (t−k).” Moreover, the electrostatic capacitance value and the contact position of the object that are input to the contact position detection unit 133 by the electrostatic capacitance-side driver 131 at the detection timing (t+k) are described collectively as “detection value C (t+k).”

The pressure, the contact position of the object, and the vector of the contact position that are input to the contact position detection unit 133 by the resistance film-side driver 132 at the detection timing (t) are described collectively as “detection value R (t).” In addition, the pressure, the contact position of the object, and the vector of the contact position that are input to the contact position detection unit 133 by the resistance film-side driver 132 at the detection timing (t−k) are described collectively as “detection value R (t−k).” Moreover, the pressure, the contact position of the object, and the vector of the contact position that are input to the contact position detection unit 133 by the resistance film-side driver 132 at the detection timing (t+k) are described collectively as “detection value R (t+k).”

Step S3: The contact position detection unit 133 stores the detection value C (t) and the detection value R (t) in the memory 126.

Step S4: The contact position detection unit 133 determines whether the pressure corresponding to the detection value R (t−1) is 0 or not. The state where the pressure corresponding to the detection value R (t−1) is 0 is when the operator does not bring an object into contact with the contact surface 101 at the detection timing (t−1) preceding the detection timing (t). When the pressure corresponding to the detection value R (t−1) is 0, it can be considered that the object newly starts to come into contact with the contact surface 101 at the detection timing (t).

When the pressure corresponding to the detection value R (t−1) is 0, the contact position detection unit 133 detects a contact position on the electrostatic capacitive touch panel 123 or the resistance film type touch panel 125 at the detection timing (t), and notifies the host device of the detected contact position (steps S5 to S8).

When, on the other hand, the pressure corresponding to the detection value R (t−1) exceeds 0, the contact position detection unit 133 executes the following processes (steps S9 to S11). In other words, even when the pressure corresponding to the detection value R (t) is less than the reference pressure at the detection timing (t), the contact position detection unit 133 executes the following processes as long as the electrostatic capacitance value corresponding to the detection value C (t) is equal to or greater than the first threshold but less than the second threshold. Specifically, the contact position detection unit 133 detects a contact position at the detection timing (t) based on the contact position corresponding to the detection value R (t−1) obtained at the detection timing (t−1) and the vector of the detection value R (t−1).

When the pressure corresponding to the detection value R (t−1) is 0 (step S4/YES), the contact position detection unit 133 moves on to step S5.

Step S5: The contact position detection unit 133 determines whether the pressure corresponding to the detection value R (t) is equal to or greater than the reference pressure. When the pressure corresponding to the detection value R (t) is equal to or greater than the reference pressure (step S5/YES), the contact position detection unit 133 moves on to step S6.

Step S6: The contact position detection unit 133 notifies the host device of the detection value R (t) stored in the memory 126. When the pressure corresponding to the detection value R (t) is equal to or greater than the reference pressure (step S5/YES), an object, whether it is conductive or not, is in contact with the contact surface 101, and the resistance film-side driver 132 detects the contact position thereof with high accuracy. Subsequently, the input device 100 notifies the host device of the contact position corresponding to the detection value R (t).

When the pressure corresponding to the detection value R (t) is determined to be less than the reference pressure in step S5 (step S5/NO), the contact position detection unit 133 moves on to step S7.

Step S7: The contact position detection unit 133 determines whether the electrostatic capacitance value corresponding to the detection value C (t) is equal to or greater than the second threshold. When the electrostatic capacitance value corresponding to the detection value C (t) is equal to or greater than the second threshold (step S7/YES), the contact position detection unit 133 moves on to step S8.

Step S8: The contact position detection unit 133 notifies the host device of the detection value C (t) stored in the memory 126. When the electrostatic capacitance value corresponding to the detection value C (t) is equal to or greater than the second threshold (step S7/YES), a conductive object is in contact with the contact surface 101, and the contact position thereof is detected by the resistance film-side driver 132 with high accuracy. Especially when the pressure upon contact is less than the reference pressure (step S5/NO), and when, for example, the operator feather-touches the contact surface 101 with the conductive object, the electrostatic capacitance-side driver 131 detects the contact position thereof with high accuracy. The input device 100 consequently notifies the host device of the contact position corresponding to the detection value C (t).

When the contact position detection unit 133 determines in step S4 that the pressure corresponding to the detection value R (t−1) is not 0 (step S4/NO), the contact position detection unit 133 moves on to step S9.

Step S9: The contact position detection unit 133 determines whether the pressure corresponding to the detection value R (t) is equal to or greater than the reference pressure. This determination process is same as that of step S5. When the pressure corresponding to the detection value R (t) is equal to or greater than the reference pressure (step S9/YES), the contact position detection unit 133 moves on to step S6. When the pressure corresponding to the detection value R (t) is less than the reference pressure due to a decrease in the contact pressure detected at the detection timing (t) (step S9/NO), the contact position detection unit 133 moves on to step S10.

Step S10: The contact position detection unit 133 determines whether the electrostatic capacitance value corresponding to the detection value C (t) is equal to or greater than the first threshold but less than the second threshold. The results of step S9 and step S10 become NO and YES respectively when the condition described below is met. Specifically, the condition is where, for instance, the operator performs the contact operation where the pressure upon contact is likely to drop, by flicking the contact surface 101 with a non-conductive object. In this contact operation, although the pressure corresponding to the detection value R (t) is less than the reference pressure (step S9/NO) and therefore the resistance film-side driver 132 does not detect the contact position thereof, the electrostatic capacitance value corresponding to the detection value C (t) is equal to or greater than the first threshold and the contact position detection unit 133 therefore determines that the object is in contact with the contact surface 101.

When the electrostatic capacitance value corresponding to the detection value C (t) is equal to or greater than the first threshold but less than the second threshold (step S10/YES), the contact position detection unit 133 moves on to step S11.

Step S11: The contact position detection unit 133 detects a contact position of the object at the detection timing (t) based on the contact position corresponding to the detection value R (t−1) and the vector of the detection value R (t−1). Note that the vector of the detection value R (t−1) is the vector of the contact position corresponding to the detection value R (t−1). Detection of the contact position was already described above in detail with reference to FIG. 6 and is therefore omitted accordingly.

Step S12: The contact position detection unit 133 notifies the host device of the detection value R (t) including the contact position of the object detected in step S11. Note that the contact position detection unit 133 stores the contact position of the object detected in step S11 in an area in the memory 126 for storing the contact position corresponding to the detection value R (t).

Step S13: The contact position detection unit 133 determines whether an end instruction operation of the input device 100 is executed or not. When the end instruction operation of the input device 100 is executed (step S13/YES), the input device 100 ends the process for detecting a contact position of an object. When the end instruction operation of the input device 100 is not executed (step S13/NO), the contact position detection unit 133 returns to step S1.

When the electrostatic capacitance value corresponding to the detection value C (t) is neither equal to or greater than the first threshold nor less than the second threshold (step S10/NO), the contact position detection unit 133 moves on to step S7. The reason that the result of step S10 is determined as NO and consequently step S7 is executed again, is to detect the contact position of a conductive object when the operator brings the conductive object into contact with the contact surface 101.

When the electrostatic capacitance value corresponding to the detection value C (t) is determined to be less than the second threshold in step S7 (step S7/NO), or, in other words, when the electrostatic capacitance value corresponding to the detection value C (t) is less than the first threshold, the contact position is not detected, and the contact position detection unit 133 move on to step S13.

(Timing Chart)

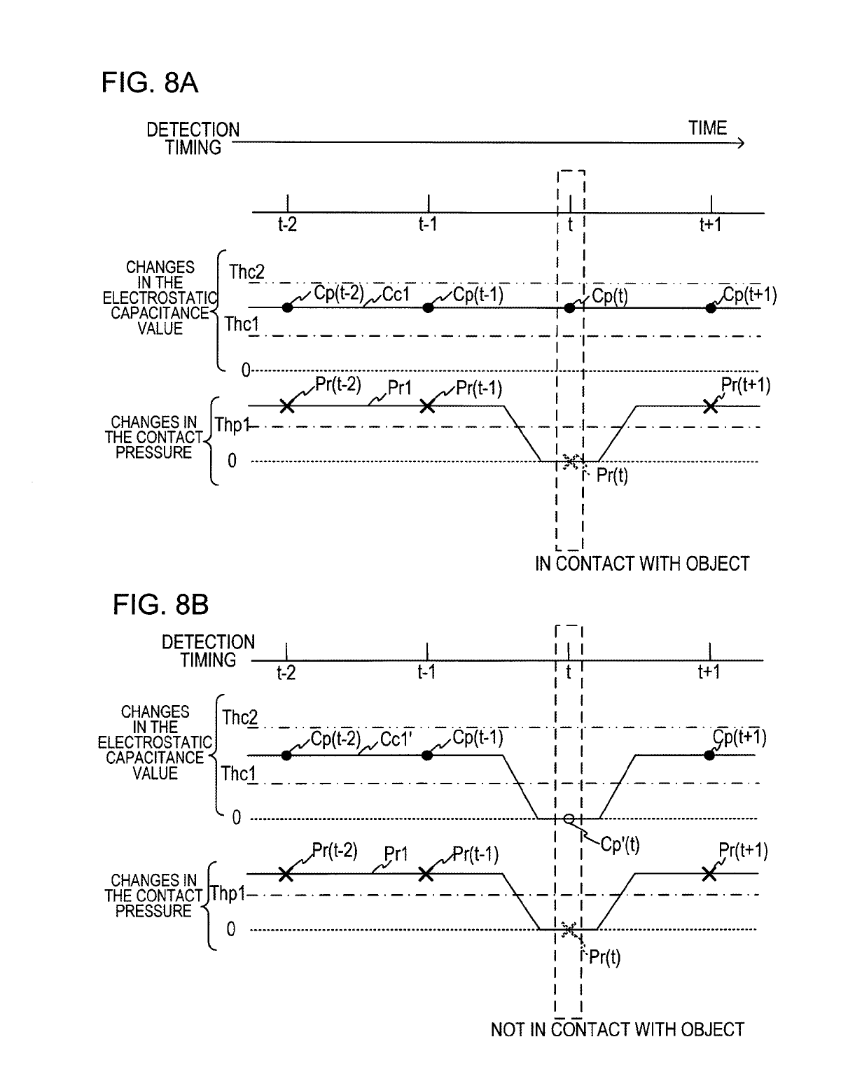

FIGS. 8A and 8B are examples of a timing chart for explaining the contact position detection process executed by the contact position detection unit 133. The arrow in FIG. 8A represents a lapse of time. FIGS. 8A and 8B each illustrate, from the top, the detection timings, changes in the electrostatic capacitance value in the electrostatic capacitive touch panel 123, and changes in the contact pressure in the resistance film type touch panel 125. Note that the detection timings are also pulses of a constant period.

FIG. 8A illustrates changes in the electrostatic capacitance value and changes in the contact pressure in a state in which the contact pressure of a non-conductive object on the contact surface 101 drops for some reason and rises back up during a contact operation performed by the operator. The operator here intends to perform the contact operation between the detection timing (t−2) and the detection timing (t+1).

The solid line indicated by reference numeral Cc1 in FIG. 8A represents the changes in the electrostatic capacitance value, and the solid line indicated by reference numeral Pr1 represents the changes in the contact pressure. For convenience of explanation, in the following description the contact pressure obtained at the detection timing (t−3) preceding the detection timing (t−2) exceeds 0. Furthermore, the electrostatic capacitance value Cc1 is equal to or greater than the first threshold Thc1 but less than the second threshold Thc2 between the detection timing (t−2) and the detection timing (t+1). In addition, the contact pressure Pr1 is equal to or greater than the reference pressure Thp1 at the detection timing (t−2) and the detection timing (t−1), but is less than the reference pressure Thp1 at the detection timing (t) and equal to or greater than the reference pressure Thp1 at the detection timing (t+1).

At the detection timing (t−2), the electrostatic capacitance-side driver 131 detects an electrostatic capacitance value Cp (t−2) and the resistance film-side driver 132 detects a contact pressure Pr (t−2), in step S2 of FIG. 7. In this case, because the contact pressure Pr (t−2) is equal to or greater than the reference pressure Thp1, the contact position detection unit 133 determines the result of step S9 as YES and notifies the host device of the detection value R (t−2) obtained at the detection timing (t−2) (step S6).

Next, at the detection timing (t−1), the electrostatic capacitance-side driver 131 detects an electrostatic capacitance value Cp (t−1) and the resistance film-side driver 132 detects a contact pressure Pr (t−1), in step S2 of FIG. 7. In this case as well, because the contact pressure Pr (t−1) is equal to or greater than the reference pressure Thp1, the contact position detection unit 133 determines the result of step S9 as YES and notifies the host device of the detection value R (t−1) obtained at the detection timing (t−1) (step S6).

Subsequently, at the detection timing (t), the electrostatic capacitance-side driver 131 detects an electrostatic capacitance value Cp (t) and the resistance film-side driver 132 detects a contact pressure Pr (t), in step S2 of FIG. 7. In this case, because the contact pressure Pr (t) is less than the reference pressure Thp1, the resistance film-side driver 132 does not detect any contact position, and the contact position detection unit 133 accordingly determines the result of step S9 as NO. Because the electrostatic capacitance value Cp (t) is equal to or greater than the first threshold Thc1 but less than the second threshold Thc2, the contact position detection unit 133 detects contact made with the electrostatic capacitive touch panel 123 and determines the result of step S10 as YES. Then, as described with reference to FIG. 6, the contact position detection unit 133 detects a contact position of the object at the detection timing (t) based on the contact position corresponding to the detection value R (t−1) and the vector of the detection value R (t−1) (step S11). The contact position detection unit 133 then notifies the host device of the detection value R (t) obtained at the detection timing (t). This detection value R (t) includes the contact position that is detected at the detection timing (t) by the contact position detection unit 133 in step S11.

Next, at the detection timing (t+1), the electrostatic capacitance-side driver 131 detects an electrostatic capacitance value Cp (t+1) and the resistance film-side driver 132 detects a contact pressure Pr (t+1), in step S2 of FIG. 7. In this case, because the contact pressure Pr (t+1) is equal to or greater than the reference pressure Thp1, the resistance film-side driver 132 detects a contact position, and the contact position detection unit 133 accordingly determines the result of step S9 as YES and notifies the host device of the detection value R (t+1) obtained at the detection timing (t+1) (step S6).

FIG. 8B illustrates changes in the electrostatic capacitance value and changes in the contact pressure in a state in which the operator intentionally releases the non-conductive object from the contact surface 101 and brings the non-conductive object back into contact with the contact surface 101 while performing the operation of bringing the non-conductive object into contact with the contact surface 101. In this case, suppose that the operator releases the object from the contact surface 101 between the detection timing (t−1) and the detection timing (t) and then brings the object into contact with the contact surface 101 between the detection timing (t) and the detection timing (t+1).

The solid line indicated by reference numeral Cc1′ in FIG. 8B represents the changes in the electrostatic capacitance value. In the following description, the contact pressure obtained at the detection timing (t−3) preceding the detection timing (t−2) exceeds 0. In addition, an electrostatic capacitance value Cc1′ is equal to or greater than the first threshold Thc1 but less than the second threshold Thc2 at the detection timing (t−2) and the detection timing (t−1), and is less than the first threshold Thc1 at the detection timing (t). Also, the electrostatic capacitance value Cc1′ is equal to or greater than the first threshold Thc1 but less than the second threshold Thc2 at the detection timing (t+1). Furthermore, the contact pressure Pr1 is equal to or greater than the reference pressure Thp1 at the detection timing (t−2) and the detection timing (t−1) but is less than the reference pressure Thp1 at the detection timing (t) and greater than or equal to the reference pressure Thp1 at the detection timing (t+1).

The processes executed at the detection timing (t−2), the detection timing (t−1), and the detection timing (t+1) were already described above with reference to FIG. 8A and are therefore omitted here accordingly. At the detection timing (t), the electrostatic capacitance-side driver 131 detects an electrostatic capacitance value Cp′(t) and the resistance film-side driver 132 detects the contact pressure Pr (t), in step S2 of FIG. 7. In this case, because the electrostatic capacitance value Cp′ (t) is less than the first threshold Thc1, the contact position detection unit 133 does not detect contact made with the electrostatic capacitive touch panel 123 and determines the results of both step S10 and step S7 as NO. Specifically, a contact position is not detected at the detection timing (t) and therefore is not reported to the host device.

Note that, when the operator brings a conductive or non-conductive object into contact with the contact surface 101 and the pressure upon contact detected at the detection timing (t) is equal to or greater than the reference pressure, the following processes illustrated in the flowchart of FIG. 7 are executed. In other words, regardless of the pressure corresponding to the detection value R (t−1) obtained at the detection timing (t−1) preceding the detection timing (t), it is determined that the pressure upon contact is equal to or greater than the reference pressure (step S5/YES or step S9/YES), and the detection value R (t) obtained in the resistance film type touch panel 125 is reported to the host device (step S6).

Also, when the operator brings a conducive object into contact with the contact surface 101, the electrostatic capacitance value corresponding to the detection value C (t) obtained at the detection timing (t) is equal to or greater than the second threshold even when the pressure upon contact detected at the detection timing (t) is less than the reference pressure. Therefore, when the pressure corresponding to the detection value R (t−1) that is detected at the detection timing (t−1) preceding the detection timing (t) is 0 (step S4/YES), it is determined that the pressure corresponding to the detection value R (t) is less than the reference pressure (step S5/NO) and that the electrostatic capacitance value corresponding to the detection value C (t) is equal to or greater than the second threshold (step S7/YES). Consequently, the detection value C (t) obtained in the electrostatic capacitive touch panel 123 is reported to the host device (step S8).

However, when the pressure corresponding to the detection value R (t−1) detected at the detection timing (t−1) exceeds 0 (step S4/NO), it is determined that the pressure corresponding to the detection value R (t) is less than the reference pressure (step S9/NO) and that the electrostatic capacitance value corresponding to the detection value C (t) is equal to or greater than the second threshold (step S10/NO, step S7/YES), and the detection value C (t) is reported to the host device (step S8).

According to the first embodiment, the contact position of the object on the contact surface is detected with high accuracy.

(First Modification)

For example, in a case where the accuracy of detecting an electrostatic capacitance value in the electrostatic capacitive touch panel 123 is low when the operator operates the contact surface 101 with a non-conductive object, in some cases it is determined that the electrostatic capacitance value is less than the first threshold and that step S11 is not executed, even when the object is in contact with the contact surface 101. In addition, in a case where the first threshold is not set appropriately, it is determined that the electrostatic capacitance value is less than the first threshold and that step S11 of FIG. 7 is not executed, even when the object is in contact with the contact surface. Therefore, the process illustrated in FIG. 7 that determines whether the electrostatic capacitance value corresponding to the detection value C (t) is equal to or greater than the first threshold but less than the second threshold (step S10), is changed to a different determination process.

A first case is simulated in which an object, conductive or non-conductive, is continuously brought into contact with the electrostatic capacitive touch panel 123. In addition, a second case is simulated in which the object is in contact with the electrostatic capacitive touch panel 123 up until the detection timing (t−1) but thereafter the object is released from the electrostatic capacitive touch panel 123. The electrostatic capacitance values to be detected are constant in the first case but not in the second case.

Specifically, the absolute value of the difference between the electrostatic capacitance value obtained at the detection timing (t−1) and the electrostatic capacitance value obtained at the detection timing (t) in the first case (also referred to as difference absolute value) is smaller than the difference absolute value between the electrostatic capacitance value obtained at the detection timing (t−1) and the electrostatic capacitance value obtained at the detection timing (t) in the second case.

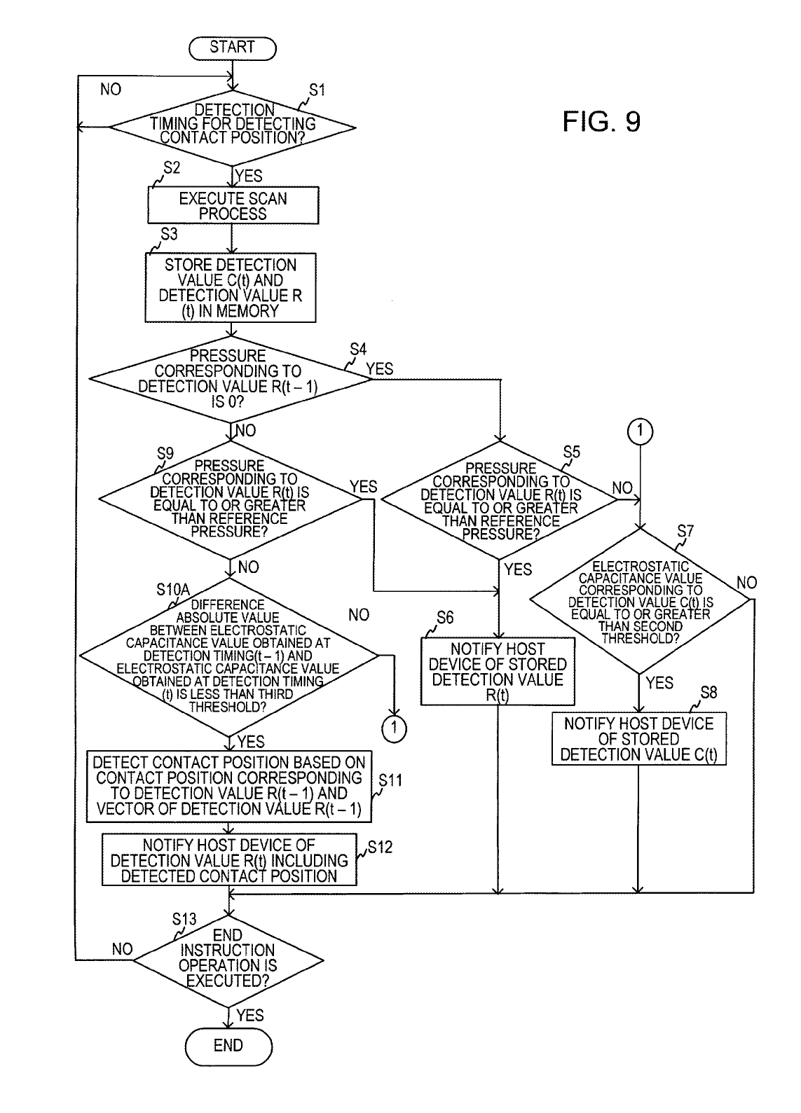

In such a case, as illustrated in the flowchart of FIG. 9, the process illustrated in FIG. 7 that determines whether the electrostatic capacitance value corresponding to the detection value C (t) is equal to or greater than the first threshold but less than the second threshold (step S10), is replaced with step S10A. FIG. 9 is another example of the flowchart for explaining the flow of the process for detecting a contact position of an object, which is executed by the contact position detection unit 133.

In step S10A of FIG. 9, the contact position detection unit 133 determines whether the difference absolute value between the electrostatic capacitance value obtained at the detection timing (t−1) and the electrostatic capacitance value obtained at the detection timing (t) is less than a third threshold (predetermined threshold) or not.

When this difference absolute value is less than the third threshold (step S10A/YES), the contact position detection unit 133 moves on to step S11. When the difference absolute value is less than the third threshold (step S10A/YES), the contact position detection unit 133 considers that an object is in contact with the contact surface 101. When, however, the difference absolute value is equal to or greater than the third threshold (step S10A/NO), the contact position detection unit 133 considers that the object is not in contact with the contact surface 101, and moves on to step S7.

Comparing the difference absolute value with the threshold in this manner enables the contact position detection unit 133 to detect a contact position of an object with high accuracy even when the accuracy of detecting an electrostatic capacitance value in the electrostatic capacitive touch panel 123 is low.

(Second Modification)

As described above, the contact position detection unit 133 detects a contact position of an object at the detection timing (t) in step S11 of FIGS. 7 and 9 based on the contact position corresponding to the detection value R (t−1) and the vector of the detection value R (t−1). The contact position corresponding to the detection value R (t−1) is the first contact position, and the vector of the detection value R (t−1) is the vector calculated based on the first contact position and the second contact position.

In other words, the contact position detection unit 133 detects the contact position at the detection timing (t) based on the first and second contact positions that are detected by the resistance film-side driver 132 within a predetermined period of time since (in other words, based on) the detection timing (t).

The first contact position is the contact position detected by the resistance film-side driver 132 at, for example, the first detection timing (t−1) preceding the detection timing (t). The second contact position was the contact position detected by the resistance film-side driver 132 at, for example, the second detection timing (t−2) preceding the first detection timing (t−1). Note, in this case, that the predetermined period of time is a time period between the detection timing (t) and the second detection timing (t−2).

Specifically, the contact position detection unit 133 detects a contact position by extrapolation.

In addition, the first contact position can be detected as it is, and the second contact position can be detected by the resistance film-side driver 132 at, for example, the second detection timing (t+1) succeeding the detection timing (t). Note, in this case, that the predetermined period of time described above is a time period between the first detection timing (t−1) and the second detection timing (t+1).

In other words, the contact position detection unit 133 detects the contact position by interpolation.

Suppose that the first contact position is the contact position P21 (t−1) and that the coordinates thereof are P21 (X₂₁, Y₂₁). Suppose also that the second contact position is a contact position P41 (t+1) and that the coordinates thereof are P41 (X₄₁, Y₄₁).

In this case, the contact position detection unit 133 detects a contact position at the detection timing (t) as a meddle point between the first contact position P21 (t−1) and the second contact position P41 (P+1). In other words, the contact position detection unit 133 computes the coordinates of the contact position detected at the detection timing (t), as Pm ((X₂₁+X₄₁)/2, (Y₂₁+Y₄₁)/2). The contact position detection unit 133 then notifies the host device of the contact position detected at the detection timing (t).

According to the second modification, the contact position detected at the detection timing (t) is interpolated based on the contact positions that are detected at the detection timings (t−1) and (t+1) preceding and succeeding the detection timing (t). Therefore, compared to when detecting a contact position by extrapolation, a contact position can be detected with higher accuracy.

(Third Modification)

The above has described the projected capacitive touch panel as an example of the electrostatic capacitive touch panel 123. A surface capacitive touch panel can also be used as the electrostatic capacitive touch panel 123. In this case, the input device 100 considers that the value of a current flowing upon contact of a conductive object with the surface capacitive touch panel is the electrostatic capacitance value, and executes various processes. The various processes are, for example, steps S7 and S10 illustrated in FIG. 7, as well as steps S7 and S10A illustrated in FIG. 9.

### Second Embodiment

The input device described in the first embodiment can be applied to an information processing device. The information processing device is a portable information processing device such as a smart phone or a tablet-type personal computer. The second embodiment describes an information processing device that is provided with the input device 100 described in the first embodiment.

(Configuration of Information Processing Device)

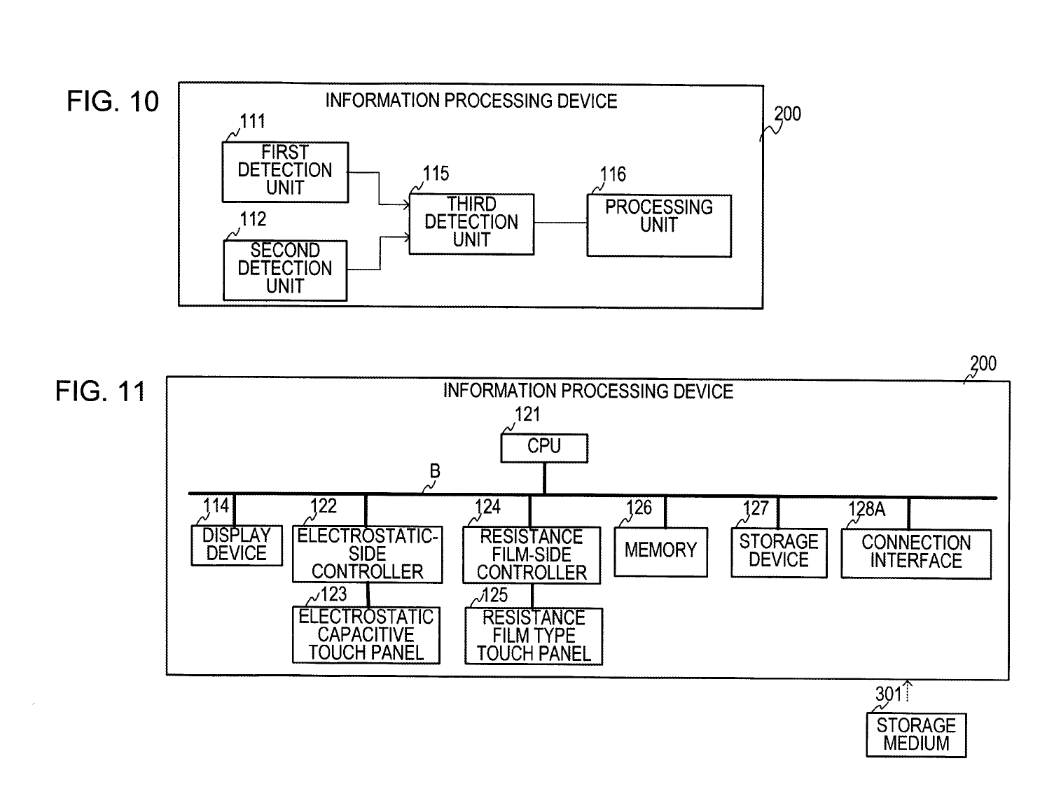

FIG. 10 is an example of a block diagram for explaining a configuration of an information processing device 200. The information processing device 200 has the first detection unit 111, the second detection unit 112, the third detection unit 115, and a processing unit 116. The first detection unit 111, the second detection unit 112, and the third detection unit 115 are the blocks of the input device 100 described in the first embodiment. The third detection unit 115 inputs, into the processing unit 116, a contact position of an object detected by the first detection unit 111, a contact position of the object detected by the second detection unit 112, or a contact position of the object detected by the third detection unit 115.

The processing unit 116 executes an information process in accordance with the contact position received from the third detection unit 115. An internal structure of the information processing device 200 is same as that of the input device illustrated in FIG. 2.

(Hardware Configuration of Information Processing Device)

FIG. 11 is an example of a block diagram for explaining a hardware configuration of the information processing device 200. The information processing device 200 has a CPU 201, the display device 114, the electrostatic-side controller 122, the electrostatic capacitive touch panel 123, the resistance film-side controller 124, and the resistance film type touch panel 125, all of which are connected to a bus B. The information processing device 200 also has the memory 126, a storage device 127A, and a connection interface 128A, all of which are connected to the bus B.

The CPU 201 is a process for controlling the entire information processing device 200. The storage device 127A is, for example, a flash memory, a hard disk drive (HDD), or other type of large-capacity storage device.

The connection interface 128A is an interface connected to an external storage medium or device, and is connected to a portable storage medium 301 such as a universal serial bus (USB). The connection interface 128A is also connected to a recording medium reading device (not illustrated) for reading data recorded in the recording medium. This recording medium is a portable recording medium such as a compact disc read only memory (CD-ROM) or a digital versatile disc (DVD).

(Software Configuration of Information Processing Device)

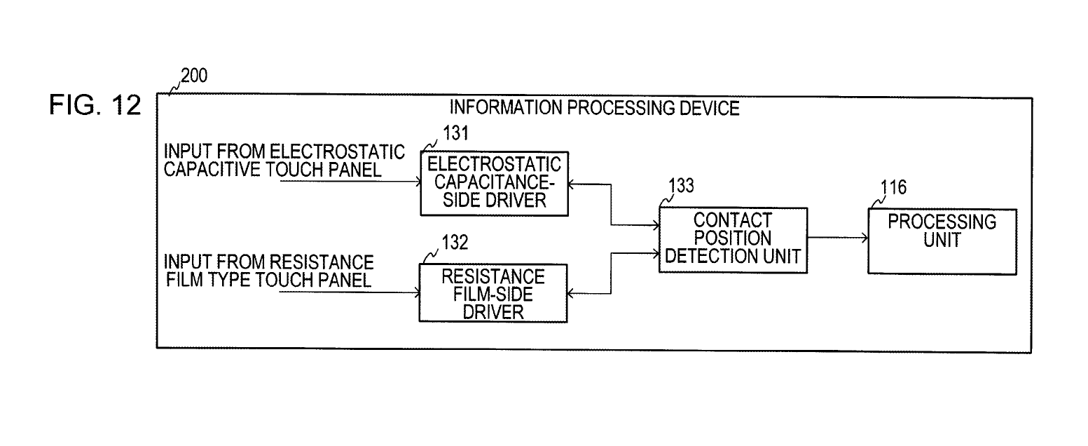

FIG. 12 is an example of a block diagram for explaining a software configuration of the information processing device 200. The information processing device 200 has the electrostatic capacitance-side driver 131, the resistance film-side driver 132, the contact position detection unit 133, and the processing unit 116. The contact position detection unit 133 inputs the detection value R (t) or detection value C (t), i.e., a contact position, into the processing unit 116.

The processing unit 116 is an application for rendering, on the display device 114, for example, a character corresponding to the contact position received from the contact position detection unit 133. The processing unit 116 is also an application for displaying an operation interface screen on the display device 114 and executing a process corresponding to the contact position, the operation interface screen having a software keyboard and an operation button.

The contact position detection unit 133 and the processing unit 116 are so-called software modules, and programs for executing the contact position detection unit 133 and the processing unit 116 respectively are stored in the storage device 127A illustrated in FIG. 11.

At the activation of the information processing device 200, the CPU 201 illustrated in FIG. 11 is caused to function as the software modules of the contact position detection unit 133 and the processing unit 116 by reading these programs stored in the storage device 127A and expanding these programs into the memory 126. Note that the storage medium 301 may store all these programs.

As described above, the input device illustrated in the first embodiment can be applied to the information processing device. The information processing device, therefore, can detect the contact operations performed on the contact surface 101, with high accuracy.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An input device, comprising:
a first detection unit which is configured to detect contact of an object with a contact surface to detect a contact position of the object;
a second detection unit which is provided on the side opposite to the contact surface and which is configured to detect a contact position of the object when a pressure upon contact of the object is equal to or greater than a reference pressure; and
a third detection unit which is configured to detect a contact position at a detection timing for detecting a contact position of the object, based on first and second contact positions that are detected by the second detection unit within a predetermined period of time since the detection timing, when the second detection unit does not detect a contact position at the detection timing but the first detection unit detects contact at the detection timing.

2. The input device according to claim 1, wherein
when the second detection unit does not detect any contact position and the first detection unit does not detect contact of the object, the third detection unit does not execute the detection of a contact position of the object based on the first and second contact positions.

3. The input device according to claim 1, wherein
the first contact position is a contact position that is detected by the second detection unit at a first detection timing preceding the detection timing, and
the second contact position is a contact position that is detected by the second detection unit at a second detection timing preceding the first detection timing.

4. The input device according to claim 1, wherein
the first contact position is a contact position that is detected by the second detection unit at a first detection timing preceding the detection timing, and
the second contact position is a contact position that is detected by the second detection unit at a second detection timing succeeding the detection timing.

5. The input device according to claim 1, wherein
the first detection unit includes an electrostatic capacitive touch panel that detects an electrostatic capacitance value between a plurality of electrodes disposed therein, and
the third detection unit determines that the object is in contact with the contact surface, when an electrostatic capacitance value detected by the first detection unit, is equal to or greater than a first threshold but less than a second threshold which is greater than the first threshold.

6. The input device according to claim 1, wherein
the first detection unit includes an electrostatic capacitive touch panel that detects an electrostatic capacitance value between a plurality of electrodes disposed therein, and
the third detection unit determines that the object is in contact with the contact surface, when a difference between a first electrostatic capacitance value detected by the first detection unit at the detection timing and a second electrostatic capacitance value detected by the first detection unit at a detection timing preceding the detection timing, is less than a predetermined threshold.

7. The input device according to claim 1, wherein
the second detection unit includes a resistance film type touch panel including a first transparent conductive film and a second transparent conductive film disposed opposite the first transparent conductive film, and detects a contact position of the object based on an electrical potential that is detected when the first and second transparent conductive films are brought into contact with each other by an external pressure.

8. An information processing device, comprising:
a first detection unit which is configured to detect contact of an object with a contact surface to detect a contact position of the object;
a second detection unit which is provided on the side opposite to the contact surface and which is configured to detect a contact position of the object when a pressure upon contact of the object is equal to or greater than a reference pressure;
a third detection unit which is configured to detect a contact position at a detection timing for detecting a contact position of the object, based on first and second contact positions that are detected by the second detection unit within a predetermined period of time since the detection timing, when the second detection unit does not detect a contact position at the detection timing but the first detection unit detects contact at the detection timing; and
a processing unit that executes an information process in accordance with the contact position.

9. A recording medium, in which is stored a program that is executed and readable by a computer and causes the computer to execute a digital signal process, the computer including a first detection unit which is configured to detect contact of an object with a contact surface to detect a contact position of the object, and a second detection unit which is provided on the side opposite to the contact surface and which is configured to detect a contact position of the object when a pressure upon contact of the object is equal to or greater than a reference pressure,
the digital signal process including:
determining whether the second detection unit does not detect any contact position but the first detection unit detects contact of the object at a detection timing for detecting a contact position of the object; and
detecting a contact position at the detection timing based on first and second contact positions that are detected by the second detection unit within a predetermined period of time since the detection timing, when the second detection unit does not detect any contact position but the first detection unit detects contact of the object.
